(19) United States
(12) Patent Application Publication
(10) Pub. No.: US 2025/0145221 A1
(43) Pub. Date: May 8, 2025

(54) VEHICLE FRONT STRUCTURE

(71) Applicant: TOYOTA JIDOSHA KABUSHIKI KAISHA, Aichi-ken (JP)

(72) Inventors: Yoshiki KOMATSU, Toyota-shi (JP); Keisuke SUZUKI, Seto-shi (JP); Kureha TAKASAKI, Toyota-shi (JP)

(21) Appl. No.: 18/938,275

(22) Filed: Nov. 6, 2024

(30) Foreign Application Priority Data
Nov. 8, 2023 (JP) 2023-190517

(51) Int. Cl. B62D 21/15

(52) U.S. Cl. CPC B62D 21/152

(57) ABSTRACT

In a vehicle front structure including a front side frame, a bumper reinforcement, and a fastening plate fastened by being sandwiched between a front end of the front side frame and a fastening portion of the bumper reinforcement, the bumper reinforcement and the fastening plate extend outward in a vehicle width direction from the front side frame, and a tip end of the fastening plate is fastened to an outer end of the bumper reinforcement, an SOL brace extending obliquely rearward from the fastening plate toward the front side frame is provided.

### CROSS REFERENCE TO RELATED APPLICATION

This application claims priority to Japanese Patent Application No. 2023-190517 filed on Nov. 8, 2023, which is incorporated herein by reference in its entirety including the specification, claims, drawings, and abstract.

### TECHNICAL FIELD

The present disclosure relates to vehicle front structures, and in particular to structures of SOL braces.

### BACKGROUND

A SOL brace that transmits an impact load at the time of a small overlap collision (hereinafter, referred to as a SOL collision) to a front side frame is used (see, for example, JPA2022-47108). The SOL brace collides with a side surface of the front side frame at the time of the SOL collision. Thus, the SOL brace transmits the impact force to the side surface of the front side frame. This impact force causes the vehicle to shift sideways, and deformation in front of the vehicle cabin is suppressed.

### SUMMARY

In the SOL collision, the barrier enters the side end portion of the bumper reinforcement on the outer side in the vehicle width direction with respect to the front side frame. Therefore, the side end portion of the bumper reinforcement may be broken by receiving a shear force in the vehicle longitudinal direction by the barrier and the front end portion of the front side frame. When the break occurs, the side end of the bumper reinforcement moves to the rear of the vehicle together with the barrier. In the vehicle front structure of the prior art, since the SOL brace is attached to the side end portion, the SOL brace may also move to the rear of the vehicle together with the side end portion at the time of the SOL collision. Therefore, in the vehicle front structure of the prior art, the impact force cannot be transmitted to the side surface of the front side frame at the time of the SOL collision, and it is difficult to suppress the deformation of the vehicle cabin front side in some cases.

Accordingly, an object of the present disclosure is to reliably transmit an impact force to a front side frame at the time of an SOL collision.

A vehicle front structure according to an embodiment of the present disclosure comprising: a front side frame disposed on a front side portion of a vehicle and extending in a vehicle longitudinal direction; a bumper reinforcement fastened to a front end of the front side frame and extending in a vehicle width direction; a fastening plate sandwiched between the front end of the front side frame and a fastening portion of the bumper reinforcement and fastened to the front end of the front side frame and the fastening portion of the bumper reinforcement, wherein the bumper reinforcement and the fastening plate extend outward in the vehicle width direction beyond the front side frame, and a tip end of the fastening plate is fastened to an outer end, in the vehicle width direction, of the bumper reinforcement; and an SOL brace attached to a rearward surface of the fastening plate, the SOL brace extending from the fastening plate obliquely rearward in the vehicle toward the front side frame.

The SOL brace is attached to the fastening plate rather than directly to the bumper reinforcement. Therefore, even if the bumper reinforcement breaks at the time of the SOL collision, the relative position with respect to the front side frame is maintained. Thus, the collision load can be transmitted from the barrier to the side surface of the front side frame. Then, the vehicle is displaced sideways due to the impact force, and deformation in front of the vehicle cabin can be suppressed.

In the vehicle front structure according to the present disclosure, the fastening plate may include an outer part extending outward in the vehicle width direction beyond the front side frame; and the outer part may be bent in a mountain shape raised rearwardly in the vehicle so as to define a gap between the outer part and a rear surface of the bumper reinforcement.

With this configuration, at the time of the SOL collision, the bumper reinforcement is crushed into the gap between the vehicle front surface of the fastening plate and the barrier to absorb the impact force. Therefore, it is possible to increase the absorption amount of the impact energy at the time of the SOL collision.

In the vehicle front structure according to the present disclosure, the fastening plate may have a ridge line raised rearwardly in the vehicle; and the SOL brace may be welded in a region outside the ridge line in the vehicle width direction to the surface of the fastening plate located rearward in the vehicle.

As described above, since the SOL brace is welded to the vehicle rear surface of the fastening plate, there is no member protruding toward the vehicle front side of the fastening plate. Thus, at the time of the SOL collision, the bumper reinforcement can sufficiently secure the gap between the vehicle front surface of the fastening plate and the barrier, and the impact force can be absorbed more.

The vehicle front structure of the present disclosure can reliably transmit the impact force to the front side frame at the time of the SOL collision.

### BRIEF DESCRIPTION OF DRAWINGS

FIG. 1 is an exploded perspective view showing a vehicle front structure of the embodiment.

FIG. 2 is a plan view showing the vehicle front structure of the embodiment.

FIG. 3 is a plan view showing deformation of each part of the vehicle having the vehicle front structure according to the embodiment in the initial stage of a collision at the time of a SOL collision.

FIG. 4 is a plan view showing the deformation of each part of the vehicle having the vehicle front structure according to the embodiment in the later stage of the collision at the time of the SOL collision.

### DESCRIPTION OF EMBODIMENTS

Hereinafter, a vehicle front structure 100 according to an embodiment will be described with reference to the drawings. Note that FR, UP, and RH shown in the drawings indicate a front side, an upper side, and a right side of the vehicle 200 including the vehicle front portion structure 100, respectively. The opposite directions of FR, UP, and RH indicate the rear side, the lower side, and the left side, respectively. Hereinafter, in the case of simply using the front-rear direction, the left-right direction, and the up-down direction, unless otherwise specified, the front-rear direction of the front-rear direction, the left-right direction of the left-right direction, and the up-down direction of the up-down direction of the vehicle 200 are indicated. The front-rear direction of the vehicle 200 is the vehicle longitudinal direction of the vehicle 200. The left-right direction of the vehicle 200 is the vehicle width direction of the vehicle 200.

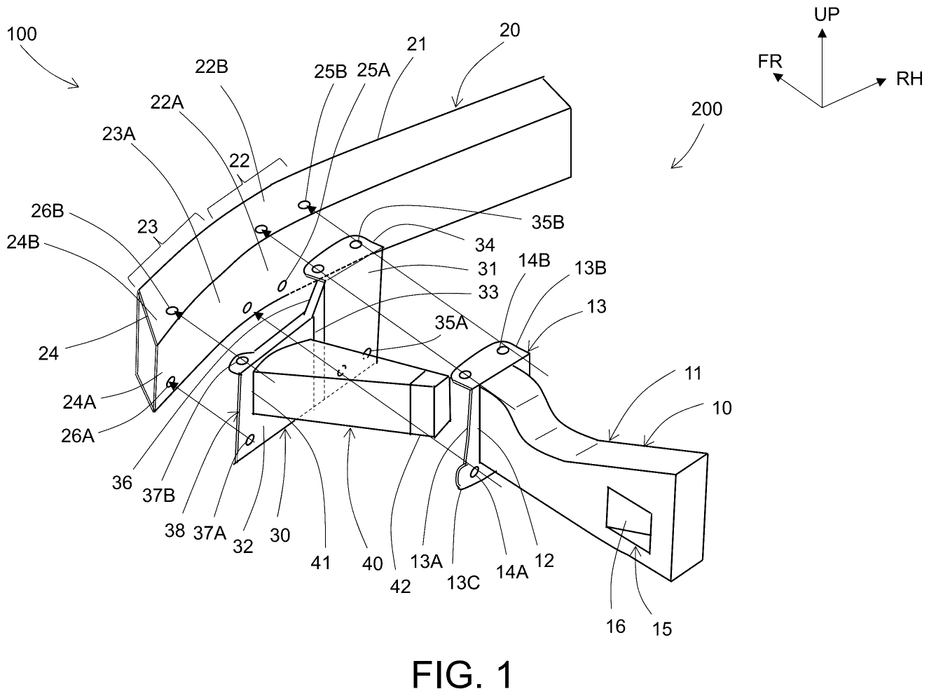

As shown in FIG. 1, the vehicle front structure 100 includes a front side frame 10, a bumper reinforcement 20, a fastening plate 30, and an SOL brace 40. In the following description, the vehicle front structure 100 on the left side of the vehicle 200 will be described, but the vehicle front structure on the right side of the vehicle 200 (not shown) is bilaterally symmetrical to the vehicle front structure 100 on the left side of the vehicle, and thus description thereof will be omitted.

The front side frame 10 is a frame member that is disposed on the left side of the front of the vehicle 200 and extends in the vehicle front-rear direction. The front side frame 10 includes a main body 11 and a front end plate 13. The main body 11 is a longitudinal member extending in the vehicle front-rear direction in a quadrangular closed cross section. An opening 15 is provided on the vehicle width direction outer side surface of the main body 11. A bulk 16 is attached to the inside of the opening 15. The bulk 16 is a reinforcing member that receives an impact load from a rear portion 42 of the SOL brace 40 described later at the time of an SOL collision.

The front end plate 13 is a plate member attached to the front end 12 of the main body 11, and includes a flat plate 13A and an upper flange 13B. The flat plate 13A is a plate member having an outer dimension larger than that of the cross section of the main body 11, protrudes to the left and right and the lower side of the main body 11, and forms a vertical flange portion 13C extending to the left and right and the lower side. The upper flange 13B is a plate member extending from the upper end of the flat plate 13A toward the front of the vehicle. A plurality of bolt holes 14A are provided in a lower portion of the vertical flange portion 13C, and a plurality of bolt holes 14B are provided in the upper flange portion 13B.

The bumper reinforcement 20 is a frame member that is fastened to the front end plate 13 of the front side frame 10 and extends in the vehicle width direction. The bumper reinforcement 20 has a square closed cross section and connects the front end plates 13 of the left and right front side frames 10 in the vehicle width direction. The bumper reinforcement 20 includes a central portion 21 at the center in the vehicle width direction, a fastening portion 22 to which the front end plate 13 of the front side frame 10 is fastened, and a side end portion 23 extending outward in the vehicle width direction from the fastening portion 22. An outer end of the side end portion 23 in the vehicle width direction is an outer end 24. Bolt holes 25A and 25B are provided in the rear surface 22A and the upper surface 22B of the fastening portion 22, respectively. A bolt hole 26B is provided in the upper surface 24B of the outer end 24, and a bolt hole 26A is provided in the rear surface 24A of the outer end 24.

The fastening plate 30 is a plate member sandwiched between the front end plate 13 of the front side frame 10 and the fastening portion 22 of the bumper reinforcement 20 and fastened to the front end plate 13 of the front side frame 10 and the fastening portion 22 of the bumper reinforcement 20.

The fastening plate 30 includes a base portion 31 and a folded plate portion 32. The base portion 31 is a plate member sandwiched between the front end plate 13 and the rear surface 22A of the fastening portion 22. An upper flange 34, which is a plate member extending toward the front of the vehicle, is provided at an upper end of the base portion 31. The upper flange 34 is provided with a plurality of bolt holes 35B. A plurality of bolt holes 35A are provided in a lower portion of the base portion 31.

The folded plate portion 32 is an outer side portion extending outward in the vehicle width direction from the base portion 31. The bent plate portion 32 is bent in a mountain shape at a ridge line 33 so as to protrude toward the vehicle rear side. An end portion of the folded plate portion 32 on the vehicle width direction outer side is a tip end 38. An upper flange 36, which is a plate member extending toward the front of the vehicle, is provided at an upper end of the folded plate portion 32. The upper flange 36 is connected to the upper flange 34 of the base portion 31. A bolt hole 37B is provided in an outer end portion of the upper flange 36 in the vehicle width direction. A bolt hole 37A is provided in a lower portion of the tip end 38.

The front portion 41 of the SOL brace 40 is attached to the vehicle rear surface of the fastening plate 30 by welding in a region outside the ridgeline 33 in the vehicle width direction. Therefore, there is no protrusion such as a bolt on the vehicle front side of the folded plate portion 32 of the fastening plate 30. The SOL brace 40 is a tapered quadrangular closed cross-sectional member whose cross-section narrows toward the rear portion 42.

Next, assembly of the front side frame 10, the bumper reinforcement 20, and the fastening plate 30 will be described. As shown by an arrow in FIG. 1, the upper flange 34 of the fastening plate 30 is superposed on the upper surface 22B of the fastening portion 22 of the bumper reinforcement 20. Further, the upper flange 36 of the fastening plate 30 is superposed on the upper surface 24B of the outer end 24. Further, the base portion 31 of the fastening plate 30 is superposed on the rear surface 22A of the fastening portion 22, and the tip end 38 of the fastening plate 30 is superposed on the rear surface 24A of the outer end 24. Then, the upper flange 13B of the front end plate 13 of the front side frame 10 is superimposed on the upper flange 34 of the fastening plate 30, and the flat plate 13A of the front end plate 13 is superimposed on the vehicle rear side surface of the base portion 31 of the fastening plate 30.

The bolt hole 14B provided in the upper flange 13B of the front end plate 13, the bolt hole 35B provided in the upper flange 34 of the fastening plate 30, and the bolt hole 25B provided in the upper surface 22B of the fastening portion 22 overlap each other to form a through hole. Similarly, the bolt hole 14A provided in the vertical flange portion 13C of the front end plate 13, the bolt hole 35A provided in the lower portion of the base portion 31, and the bolt hole 25A provided in the rear surface 22A of the fastening portion 22 overlap each other to form a through hole. The bolt hole 37B provided in the upper flange 36 of the fastening plate 30 overlaps with the bolt hole 26B provided in the upper surface 24B of the outer end 24 to form a through hole. Further, the bolt hole 37A provided in the tip end 38 of the fastening plate 30 overlaps with the bolt hole 26A provided in the rear surface 24A of the outer end 24 to form a through hole.

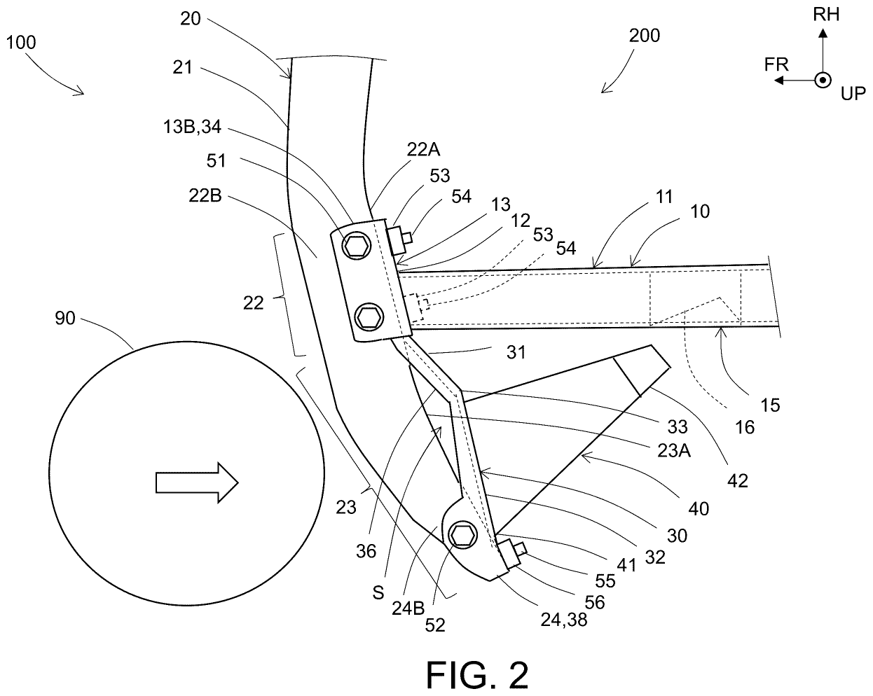

Then, as shown in FIG. 2, bolts 51 are inserted into the bolt holes 14B, 35B, and 25B to fasten the upper flanges 13B and 34 to the upper surface 22B of the fastening portion 22. Similarly, bolts 52 are inserted into the bolt holes 37B and 26B to fasten the upper flange 36 to the upper surface 24B of the outer end 24. In addition, the nut 53 is tightened from the vehicle rear side through the bolt 54 in the bolt holes 25A, 35A, and 14A. Thus, the flat plate 13A and the base portion 31 are fastened to the rear surface 22A of the fastening portion 22. The nut 56 is tightened from the rear of the vehicle through the bolt 55 in the bolt holes 26A and 37A. Thus, the tip end 38 of the fastening plate 30 is fastened to the outer end 24. As described above, the fastening plate 30 is sandwiched between the front end 12 of the front side frame 10 and the fastening portion 22 of the bumper reinforcement 20 and fastened to the front end 12 and the fastening portion 22. The tip end 38 of the fastening plate 30 is fastened to the outer end 24 of the bumper reinforcement 20.

As shown in FIG. 2, when the fastening plate 30 is sandwiched and fastened between the front side frame 10 and the bumper reinforcement 20, the bumper reinforcement 20 and the fastening plate 30 extend further outward in the vehicle width direction than the front side frame 10. A gap S is provided between the folded plate portion 32 of the fastening plate 30 and the rear surface 23A of the side end portion 23. The rear portion 42 of the SOL brace 40 extends obliquely rearward from the fastening plate 30 toward the vehicle width direction outer side surface of the front side frame 10.

Next, deformation of each part of the vehicle 200 including the vehicle front structure 100 at the time of the SOL collision will be described with reference to FIGS. 2 to 4. As shown in FIG. 2, in the SOL collision, the barrier 90 enters the side end portion 23 of the bumper reinforcement 20. The side end portion 23 is located outside the front side frame 10 in the vehicle width direction.

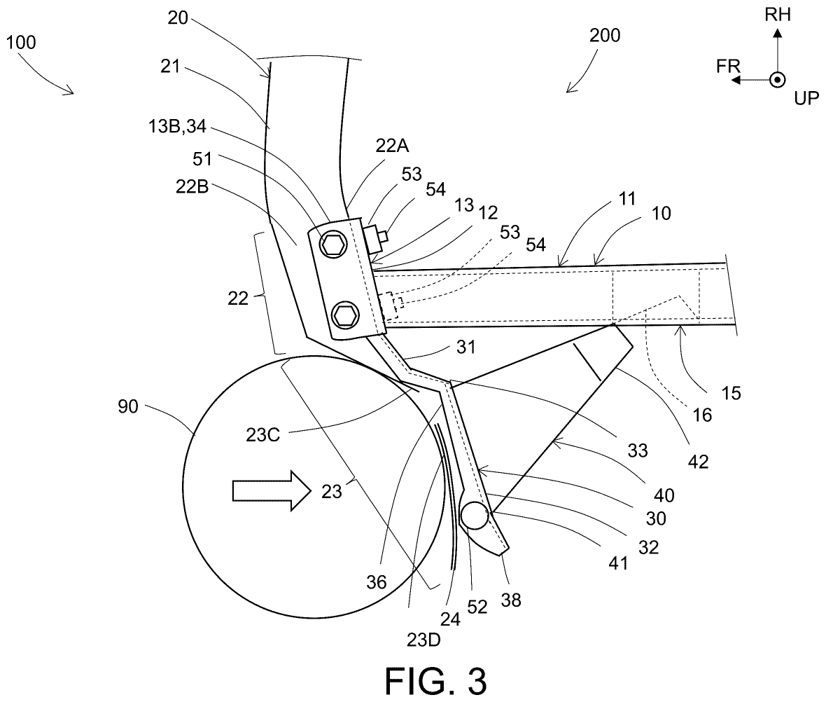

As shown in FIG. 2, there is a gap S between the folded plate portion 32 of the fastening plate 30 and the rear surface 23A of the side end portion 23. Therefore, when the barrier 90 collides with the front of the side end portion 23 of the bumper reinforcement 20 by the SOL collision, as shown in FIG. 3, the side end portion 23 is crushed in the vehicle front-rear direction by the gap S between the vehicle front surface of the fastening plate 30 and the barrier 90. The impact force is absorbed by the collapse of the bumper reinforcement 20.

The side end portion 23 receives a shear force in the vehicle front-rear direction by the barrier 90 and the front end 12 of the front side frame 10. As a result, the side end portion 23 breaks into a portion 23C adjacent to the fastening portion 22 and a portion 23D including the outer end 24. At this time, the fastening plate 30 is not broken although the bent plate portion 32 is bent toward the vehicle rear side. Since the SOL brace 40 is welded and fixed to the fastening plate 30, even when the side end portion 23 of the bumper reinforcement 20 breaks, the rear portion 42 maintains a state of extending obliquely rearward from the fastening plate 30 toward the vehicle width direction outer side surface of the front side frame 10.

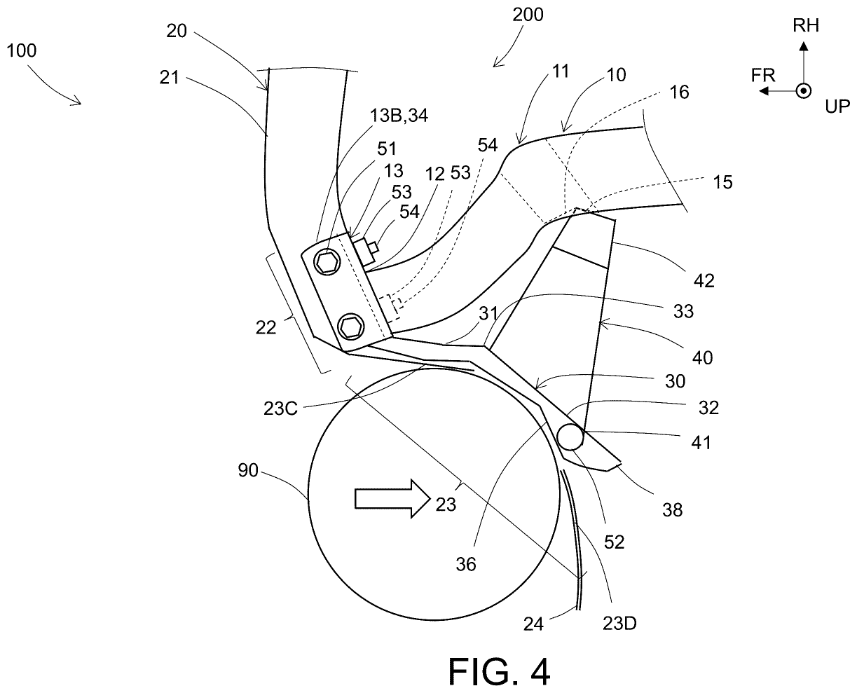

As shown in FIG. 4, when the barrier 90 further enters, the rear portion 42 of the SOL brace 40 enters the opening 15 of the front side frame 10 and abuts the bulk 16 disposed therein. Thus, a force directed to the right of the vehicle 200 is input from the SOL brace 40 to the front side frame 10. Then, the vehicle 200 shifts sideways in the right direction, and the barrier 90 passes through the left side surface of the vehicle 200. Thus, entry of the barrier 90 into the vehicle cabin can be suppressed. As a result, the deformation of the vehicle cabin front side due to the barrier 90 can be suppressed.

As described above, in the vehicle front structure 100, since the SOL brace 40 is attached to the fastening plate 30, even if the bumper reinforcement 20 breaks at the time of the SOL collision, the relative position with respect to the front side frame 10 is held by the fastening plate 30. Thus, the collision load can be transmitted from the barrier 90 to the side surface of the front side frame 10. Then, the vehicle 200 can be displaced sideways by the transmitted collision load. Accordingly, deformation of the vehicle cabin front side at the time of the SOL collision can be suppressed.

Further, in the vehicle front structure 100, at the time of the SOL collision, the bumper reinforcement 20 is crushed by the gap S between the vehicle front surface of the fastening plate 30 and the barrier 90 to absorb the impact force, so that the absorption amount of the impact energy can be increased. Further, since the SOL brace 40 is welded to the vehicle rear surface of the fastening plate 30, there is no member protruding toward the vehicle front side of the fastening plate 30, and the gap S between the vehicle front surface of the fastening plate 30 and the barrier 90 can be sufficiently secured. This increases the amount of collapse of the bumper reinforcement 20 between the fastening plate 30 and the barrier 90 at the time of the SOL collision. Therefore, the vehicle front structure 100 can absorb more impact force.

In the above description, the fastening plate 30 is constituted by the base portion 31 and the bent plate portion 32 which is convex in a mountain shape. For example, it may be constituted by the base portion 31 and a flat plate-shaped end plate portion extending from the base portion 31 toward the outer end 24 of the bumper reinforcement 20. In this case, since the width of the gap S becomes narrow, although the amount of absorption of the impact force becomes smaller than that of the vehicle front structure 100 described above, similarly to the vehicle front structure 100, the transmission of the collision load from the barrier 90 to the side surface of the front side frame 10 at the time of the SOL collision becomes possible, and the deformation in the front of the vehicle cabin can be suppressed.

1. A vehicle front structure comprising:
a front side frame disposed on a front side portion of a vehicle and extending in a vehicle longitudinal direction;
a bumper reinforcement fastened to a front end of the front side frame and extending in a vehicle width direction;
a fastening plate sandwiched between the front end of the front side frame and a fastening portion of the bumper reinforcement and fastened to the front end of the front side frame and the fastening portion of the bumper reinforcement, wherein the bumper reinforcement and the fastening plate extend outward in the vehicle width direction beyond the front side frame, and a tip end of the fastening plate is fastened to an outer end, in the vehicle width direction, of the bumper reinforcement; and
an SOL brace attached to a rearward surface of the fastening plate, the SOL brace extending from the fastening plate obliquely rearward in the vehicle toward the front side frame.

2. The vehicle front structure according to claim 1, wherein
the fastening plate includes an outer part extending outward in the vehicle width direction beyond the front side frame; and
the outer part is bent in a mountain shape raised rearwardly in the vehicle so as to define a gap between the outer part and a rear surface of the bumper reinforcement.

3. The vehicle front structure according to claim 2, wherein
the fastening plate has a ridge line raised rearwardly in the vehicle; and
the SOL brace is welded in a region outside the ridge line in the vehicle width direction to the surface of the fastening plate located rearward in the vehicle.
